(19) United States
(12) Patent Application Publication
(10) Pub. No.: US 2022/0314788 A1
(43) Pub. Date: Oct. 6, 2022

(54) HEAVY-DUTY VEHICLE AND ELECTRIC DRIVELINE SYSTEM

(71) Applicant: HYZON Motors Inc., Honeoye Falls, NY (US)

(72) Inventors: Qunlong Dong, Ellicott City, MD (US); Jay A. De Veny, III, Birmingham, MI (US); George Gu, Naperville, IL (US)

(21) Appl. No.: 17/705,949

(22) Filed: Mar. 28, 2022

Related U.S. Application Data
(60) Provisional application No. 63/166,664, filed on Mar. 26, 2021.

(51) Int. Cl. B60K 17/04; B60K 7/00

(52) U.S. Cl. CPC B60K 17/043; B60K 7/0007; B60K 2007/0061

(57) ABSTRACT

A heavy-duty vehicle having a chassis, a front steering axle, and first and second rear axles. The first rear axle may include a first rear axle housing, a first carrier housing, and a second carrier housing and the second rear axle may include a second axle housing, a third carrier housing, and a fourth carrier housing. A first permanent magnet motor may be coupled to the first carrier housing and engaged with a first gearset, and a second permanent magnet motor may be coupled to the second carrier housing and engaged with a second gearset. A first induction motor may be coupled to the third carrier housing and engaged with a third gearset, and a second induction motor may be coupled to the fourth carrier housing and engaged with a fourth gearset.

### CROSS-REFERENCE TO RELATED APPLICATIONS

The subject patent application claims priority to, and all the benefits of, U.S. Provisional Patent Application [symbol] o. 63/166,664, filed on Mar. 26, 2021, the entire contents of which are incorporated by reference herein.

### BACKGROUND

Unlike vehicles powered by traditional internal combustion engines where energy conversion efficiency may increase with load levels and thus specific energy consumption, measured in mile/gallon or in gram/kWh, generally deteriorates less significantly with driveline losses since the losses increase the engines' load levels. Electric vehicles, including hybrid electric vehicles, battery electric vehicles (BEV), and fuel cell electric vehicles, tend to have specific energy consumptions more sensitive to driveline losses because electric motors have very low losses across most of their operation range. Reducing driveline losses becomes more effective in increasing electric vehicles' drive ranges or cutting the costs of their energy storage systems if ranges are to be maintained the same.

Various efforts have been implemented to minimize the driveline loss for electric vehicles. Using 2 speed or multiple speed transmission to keep the operating points in the high efficiency zoom of the electric motors is a widely used approach with approved effectiveness. However, due to the losses from additional gear meshing and rotating mass from additional gears, the effectiveness in overall loss reduction tends to be quite limited. Another direction is to use in-wheel motors by eliminating the gear meshing and oil stirring losses. To fulfill the needs of launch-ability and grade-ability of vehicles, the motors tend to be heavy and expensive due to its high usage of rare earth magnet and other raw materials. While during normal power operation, for example cruising at highway on flat roads, the electromagnetic drag from the large motors tend to diminish considerable fraction of eliminating the gears.

### SUMMARY

In one aspect, a heavy-duty vehicle having a chassis extending along a centerline, the heavy-duty vehicle may comprise a front steering axle having a pair of wheels configured for movement relative to the heavy-duty vehicle. The heavy-duty vehicle may further comprise a first rear axle and a second rear axle. The first rear axle may comprise a first axle housing coupled to the chassis and supporting a first axle shaft coupled to a first wheel and a second axle shaft coupled to a second wheel with the first and second wheels arranged on opposing sides of the centerline. The first rear axle may further comprise a first carrier housing coupled to the first axle housing, and a first permanent magnet motor mounted directly to the first carrier housing for driving the first wheel. The first rear axle may further comprise a first gearset rotatably supported at least partially in the first carrier housing and operatively engaged between the first permanent magnet motor and the first axle shaft. The first rear axle may further comprise a second carrier housing coupled to the first axle housing and a second permanent magnet motor coupled to the second carrier housing for driving the second wheel. The first rear axle may further comprise a second gearset rotatably supported at least partially in the second carrier housing and operatively engaged between the second permanent magnet motor and the second axle shaft. The first gearset and the second gearset may be configured such that the first gearset is rotationally independent from the second gearset. The second rear axle may comprise a second axle housing coupled to the chassis and supporting a third axle shaft coupled to a third wheel and a fourth axle shaft coupled to a fourth wheel with the third and fourth wheels arranged on opposing sides of the centerline. The second rear axle may further comprise a third carrier housing coupled to the second axle housing and a first induction motor mounted directly to the third carrier housing for driving the third wheel. The second rear axle may further comprise a third gearset rotatably supported at least partially in the third carrier housing and operatively engaged between the first induction motor and the third axle shaft. The second rear axle may further comprise a fourth carrier housing coupled to the second axle housing and a second induction motor mounted directly to the fourth carrier housing for driving the fourth wheel. The second rear axle may further comprise a fourth gearset rotatably supported at least partially in the fourth carrier housing and operatively engaged between the second induction motor and the fourth axle shaft. The third gearset and the fourth gearset may be configured such that the third gearset is rotationally independent from the fourth gearset.

In another aspect, a driveline system for a heavy-duty vehicle including a chassis, a front steering axle coupled to the chassis and having a pair of wheels arranged on opposing sides of a vehicle centerline and configured for turning the heavy-duty vehicle. The driveline system may comprise a first rear axle and a second rear axle. The first rear axle may comprise a first axle housing coupled to the chassis. The first axle housing may support a first axle shaft coupled to a first wheel and a second axle shaft coupled to a second wheel with the first and second wheels arranged on opposing sides of the vehicle centerline. The first rear axle may further comprise a first permanent magnet motor coupled to the first axle housing for driving the first wheel and a first gearset operatively engaged between the first permanent magnet motor and the first axle shaft. The first rear axle may further comprise a second permanent magnet motor coupled to the first axle housing for driving the second wheel and a second gearset operatively engaged between the second permanent magnet motor and the second axle shaft. The second rear axle may comprise a second axle housing coupled to the chassis and supporting a third axle shaft coupled to a third wheel and a fourth axle shaft coupled to a fourth wheel with the third and fourth wheels arranged on opposing sides of the centerline. The second rear axle may further comprise a first induction motor coupled to the second axle housing for driving the third wheel and a third gearset operatively engaged between the first induction motor and the third axle shaft. The second rear axle may further comprise a second induction motor coupled to the second axle housing for driving the fourth wheel and a fourth gearset operatively engaged between the second induction motor and the fourth axle shaft.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a rear perspective view of a heavy-duty vehicle having a body supported on a chassis, and a driveline system including a front steering axle and two rear axles.

FIG. 2 is a bottom view of heavy-duty vehicle with the body removed showing the front steering axle and the two rear axles coupled to the chassis.

FIG. 3 is a perspective view of a rear axle for the heavy-duty vehicle showing an axle housing, first and second carrier housings, and two motors coupled to the carrier housings.

FIG. 4 is another perspective view of the rear axle of FIG. 3 showing the axle housing, two carrier housings, and two motors coupled to the carrier housings.

FIG. 5 is a partially exploded perspective view of the rear axle of FIG. 3 showing the carrier housings and motors removed from the axle housing and with a gearset shown rotatably supported in each of the carrier housings.

FIG. 6 is a top view of the carrier housings and two axle shafts of FIG. 5 with the axle housing removed showing each axle shaft engaged with one of the gearsets.

FIG. 7 is a bottom view of one gearset and motor of FIG. 6 shown with the carrier housing in phantom.

FIG. 8 is a top view of the gearsets of FIG. 6 with the carrier housings removed showing the arrangement of each gearset and the motors.

FIG. 9 is an exploded view of one of the gearsets showing the motor, an input gear, first and second intermediate gears, and an output gear.

FIG. 10 is a cross-sectional perspective view of one of the carrier housings showing the output gear, the second intermediate gear engaged with the output gear, and the input gear.

FIG. 11 is another cross-sectional perspective view of one of the carrier housings showing the input gear, the first intermediate gear engaged with the input gear, and the output gear.

FIG. 12 is a cross-sectional view of one of the carrier housings showing the first and second intermediate gears supported on an intermediate shaft, and lubricant sump of the carrier housing.

FIG. 13 is a side view of the gearset showing the motor, the input gear, the first and second intermediate gears, and the output gear.

FIG. 14 is a perspective view of the gearset of FIG. 13 showing the motor, the input gear, the first and second intermediate gears, the output gear and the axle shaft engaged with the output gear.

### DETAILED DESCRIPTION

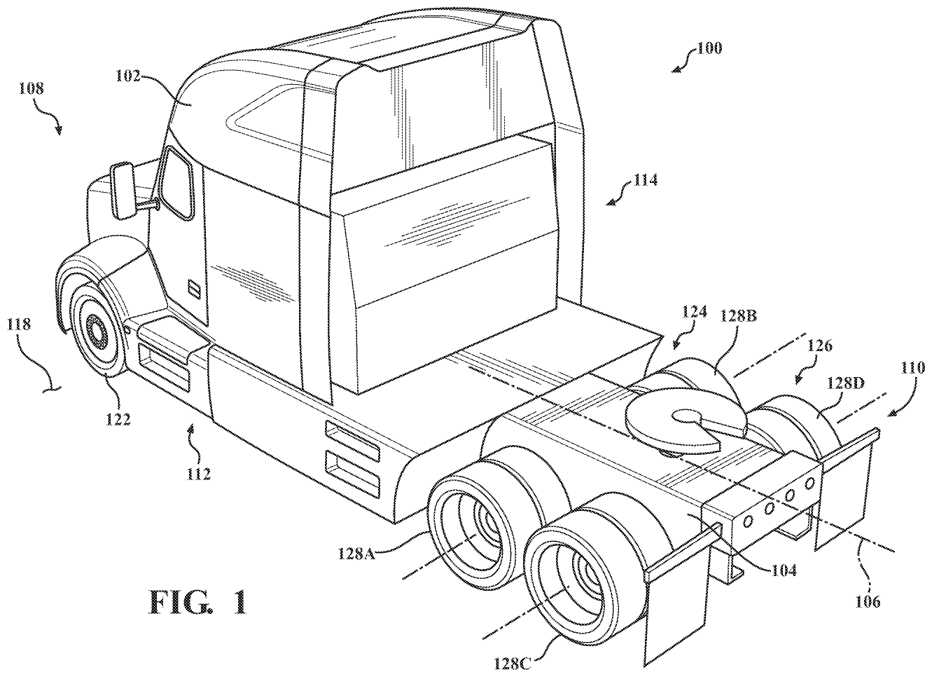

FIG. 1 shows a heavy-duty vehicle 100 used for transporting heavy and/or large cargo. The exemplary heavy-duty vehicle 100 illustrated here is shown as a tractor unit, such as a Class 8 semi-truck configured for towing a semi-trailer (not shown). The heavy-duty vehicle 100 may take other forms such as a straight truck (e.g., a dump truck) or a bare chassis, such as may be used for a mobile crane. The heavy-duty vehicle generally comprises a body 102, which may include a cab with controls usable by an operator to drive the heavy-duty vehicle 100. The body 102 may further comprise a sleeper with living quarters for the operator. Other implementations of the body may include cargo carrying equipment such as an enclosed cargo box, a dump box, or wrecker equipment (e.g., a wheel lift or flatbed). The heavy-duty vehicle 100 further comprises a chassis 104 supporting the body 102. The chassis 104 extends along a vehicle centerline 106 from a front end 108 to a rear end 110, according to the primary direction of travel of the heavy-duty vehicle 100. The centerline 106 further defines a left side 112 and a right side 114 of the chassis 104.

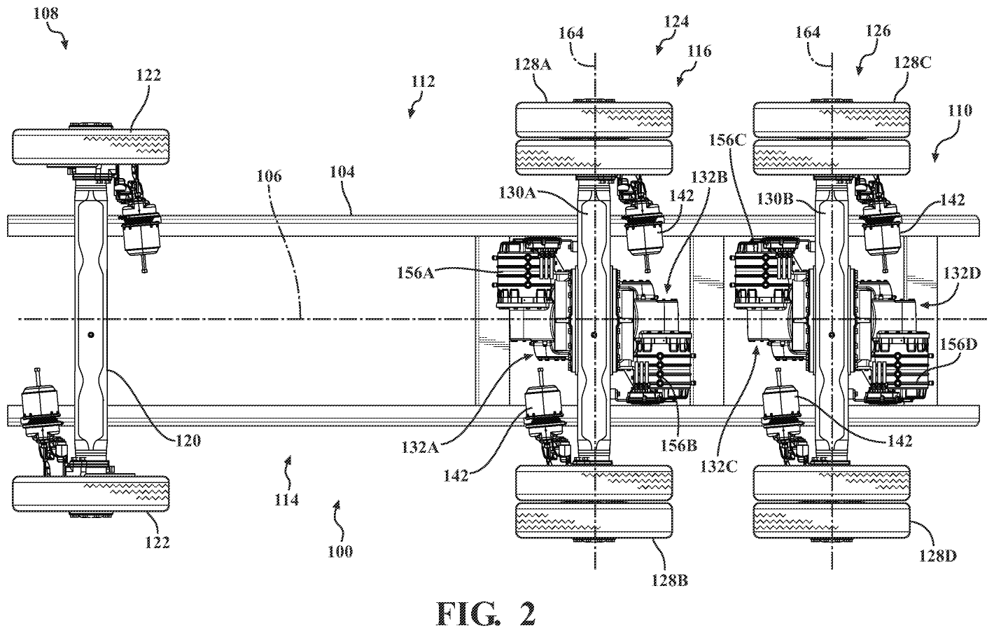

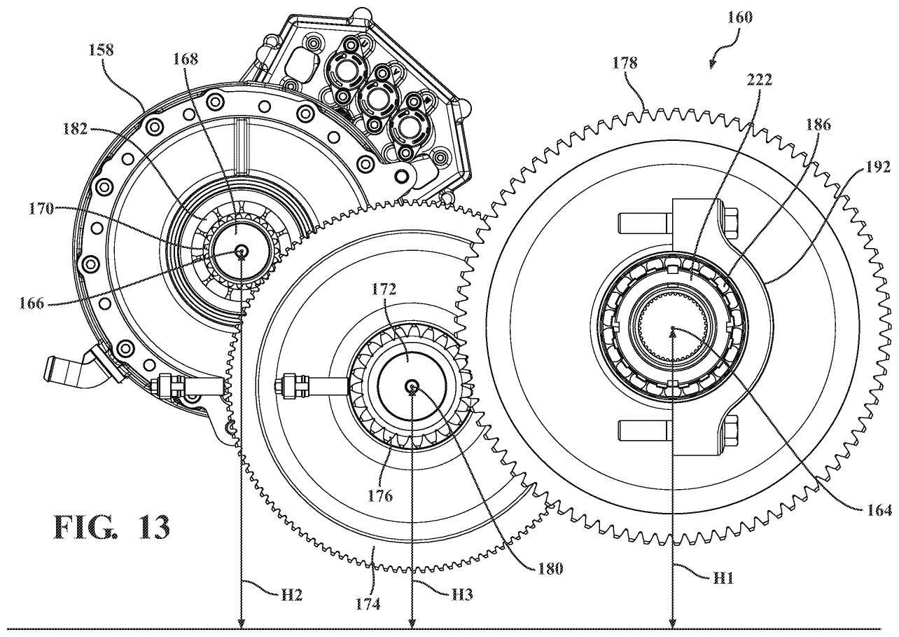

The heavy-duty vehicle 100 may further comprise a driveline system 116 to facilitate locomotion of the heavy-duty vehicle 100 along a ground surface such as a roadway 118 (see: FIG. 13) or other surfaces. The driveline system 116 illustrated here may comprise a steering axle 120 arranged toward the front end 108 and coupled to the chassis 104. The steering axle 120 is generally perpendicular to the centerline 106 and extends from the left side 112 to the right side 114. The steering axle 120 may comprise a pair of steer wheels, with one steer wheel 122 arranged on each of the left and right sides 112, 114. The steer wheels 122 are configured for pivoting movement about a kingpin relative to the centerline 106. In some implementations the driveline system 116 may comprise more than one steering axle, each having a pair of steer wheels. The exemplary steering axle 120 illustrated in FIGS. 1 and 2 is unpowered (i.e., the steer wheels 122 cannot propel the heavy-duty vehicle 100), however some implementations of the heavy-duty vehicle 100 may utilize a powered steering axle (not shown), such as off-road vehicles.

The driveline system 116 may further comprise a first rear axle 124 and a second rear axle 126 arranged toward the rear end 110 of the heavy-duty vehicle 100 and coupled to the chassis 104 in a tandem configuration. Similar to the steering axle 120, the first rear axle 124 and the second rear axle 126 are each generally perpendicular to the centerline 106 and extend from the left side 112 to the right side 114. Each rear axle comprises a wheel 128 arranged on each opposing end of the rear axle on the left side 112 and the right side 114. More specifically, the first rear axle 124 comprises a first wheel 128A and a second wheel 128B and the second rear axle 126 comprises a third wheel 128C and a fourth wheel 128D. The wheels 128 shown here are illustrated as a “dual” wheel, which include a pair of wheels coupled together and facilitate an increased load capacity of the heavy-duty vehicle 100. The dual wheels further contribute to increased reliability through redundancy in case of a damaged or otherwise deflated tire. The wheels 128 may also be single wheels having an extra wide configuration, colloquially known as a “super-single”.

As shown in FIG. 2, the first and second rear axles 124, 126 are powered axles comprising motors (discussed below) for propelling the heavy-duty vehicle 100 along the roadway. The exemplary driveline system 116 as configured with powered first and second rear axles 124, 126 and an unpowered steering axle is commonly referred to as a 6×4 configuration, for six total wheels and four driven wheels. The heavy-duty vehicle 100 is a fully electric vehicle, with each of the rear axles 124, 126 utilizing exclusively electric motors and are not mechanically coupled to an internal combustion engine. As mentioned above, the heavy-duty vehicle 100 may be equipped with a powered steering axle (not shown), which would result in a driveline system with a 6×6 configuration.

Each of the first and second rear axles 124, 126 are generally configured with a similar arrangement. More specifically, with the exception of the differences discussed in further detail below, the first rear axle 124 is generally the same as the second rear axle 126. To this end, components that are structurally similar between each of the first rear axle 124 and the second rear axle 126 are identified with the same reference number, and with individual elements appended with A, B, C, and D, as appropriate, for respective first, second, third, and fourth iterations included with the same heavy-duty vehicle 100. More specifically, when referring to individual components and their arrangement or configuration relative to each other the reference numbers are appended with A, B, C, and D as appropriate (e.g., first wheel 128A, second wheel 128B . . . fourth wheel 128D), and when referring to the components collectively the reference number is used without a letter (e.g., wheels 128). As such, in FIGS. 1 and 2, the first rear axle 124 and second rear axle 126 are shown with the first and second wheels 128A, 128B coupled to the first rear axle 124 and the third and fourth wheels 128C, 128D coupled to the second rear axle 126. Furthermore, each of the first rear axle 124 and the second rear axle 126 comprises an axle housing 130. The first rear axle comprises a first axle assembly 130A and the second rear axle 126 comprises a second axle housing 130B. Further still, each of the first rear axle 124 and the second rear axle 126 comprises two carrier assemblies 132. A first carrier assembly 132A and a second carrier assembly 132B are coupled to the first rear axle 124, and a third carrier assembly 132C and a fourth carrier assembly 132D are coupled to the second rear axle 126.

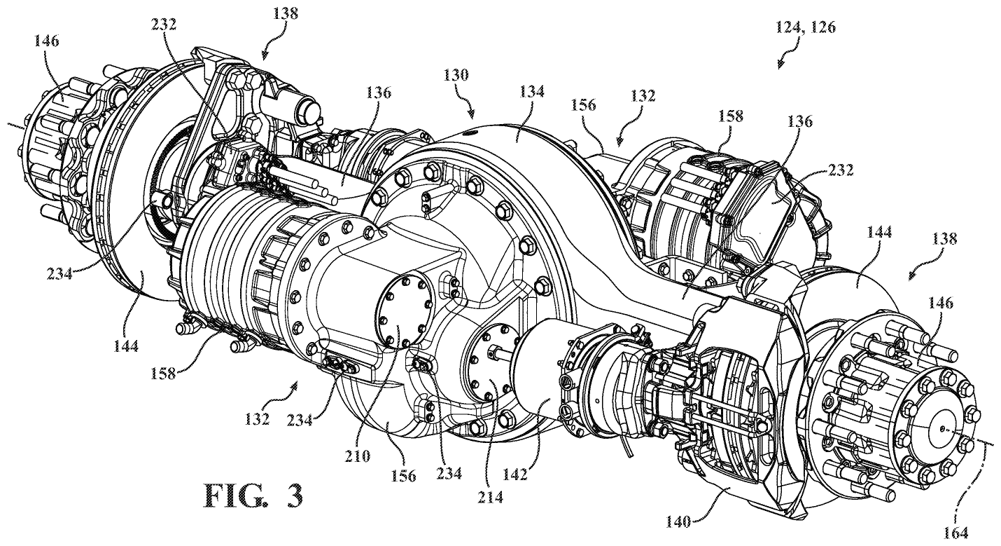

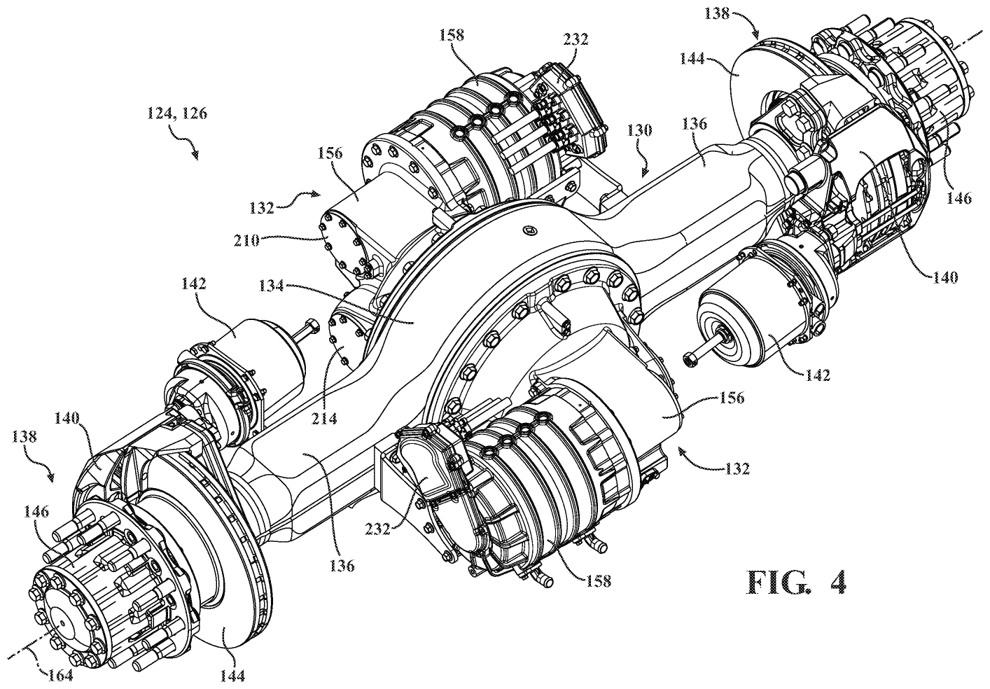

Looking to FIGS. 3 and 4, one of the rear axles 124, 126 is shown without the heavy-duty vehicle 100 or the chassis 104. As mentioned above, the rear axle 124, 126 comprises the axle housing 130, which comprises a center section 134, two axle tubes 136 protruding from opposing sides of the center section 134, and wheel ends 138 arranged at a distal end of each axle tube 136. Each wheel end 138 may comprise brakes for slowing the heavy-duty vehicle 100. The brakes may be implemented as drum brakes or disc brakes, as shown here. The disc brakes may comprise calipers 140 and actuators 142 coupled to the axle housing 130, and rotors 144 coupled to the wheels 128. Each of the wheel ends 138 may further comprise a hub assembly 146 rotatably supported on the axle tubes 136 by bearings.

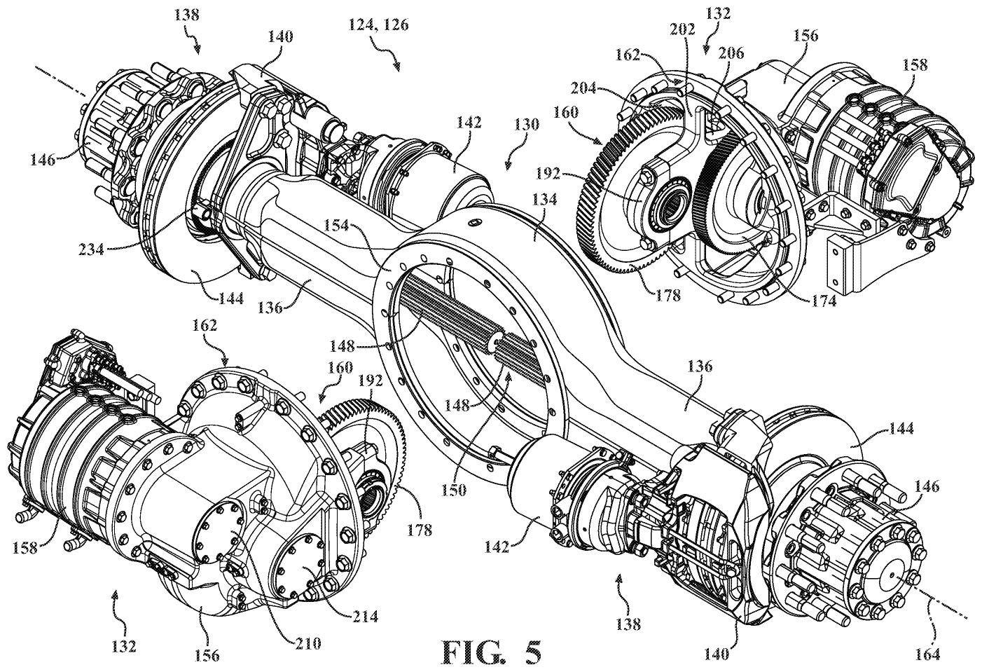

Each of the rear axles 124, 126 further comprises two axle shafts 148 disposed in the axle tubes 136 extending between the center section 134 and the wheel ends 138. The hub assemblies 146 are coupled to the wheels 128 and to the axle shafts 148 for transferring torque therebetween. Best shown in FIG. 5, each of the axle shafts 148 comprises a spline end 150 and a flange end 152. The spline end 150 is arranged in the center section 134 and configured for engagement with the carrier assembly 132 and the flange end 152 is arranged at the wheel end 138 and configured for engagement with the hub assembly 146.

Comparing FIGS. 3 and 5, the carrier assemblies 132 are shown coupled to the axle housing 130 in FIG. 3 and removed from the axle housing 130 in FIG. 5. Each carrier assembly 132 may be coupled to the center section 134 of the corresponding axle housing 130. More specifically, the center section 134 of each of the rear axles 124, 126 comprises two housing flanges 154 arranged on longitudinally opposing sides of the axle housing 130 and generally perpendicular to the centerline 106 of the heavy-duty vehicle 100. The housing flange 154 is configured to engage the carrier assembly 132 such that the carrier assembly 132 can be secured with a plurality of fasteners.

The rear axle 124, 126 shown in FIG. 5 further illustrates details of each carrier assembly 132. Each of the carrier assemblies 132 comprises a carrier housing 156, a motor 158, and a gearset 160 rotatably support at least partially in the carrier housing 156. A first carrier housing 156A and a second carrier housing 156B are arranged on opposing sides of the axle housing 130 and spaced along the centerline 106. Each gearset 160 is operatively engaged between the motor 158 and the axle shaft 148. Each motor 158 is mounted directly to the carrier housing 156 for driving the respective wheel 128 (e.g., the first motor 158A is mounted directly to a first carrier housing 156A for driving the first wheel 128A). As will be discussed in greater detail below, the motors 158 are of differing types and configuration. The carrier housing 156 further comprises a carrier flange 162 engageable with the housing flange 154 of the axle housing 130. The carrier flange 162 has a generally circular shape with an outer lip defining a plurality of fastener holes. Each of the fastener holes are sized and shaped to receive a fastener, which is engaged with the axle housing 130 to secure the carrier housing 156 to the axle housing 130.

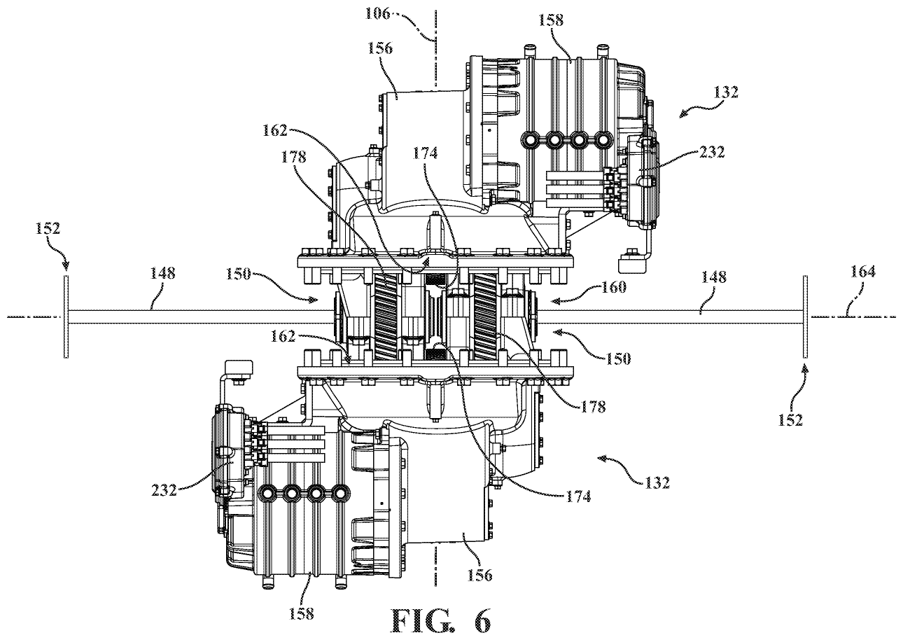

Referring now to FIG. 6, a top view of two carrier assemblies 132 is shown without the axle housing 130. In this view, the axle shafts 148 are shown operatively engaged with the gearsets 160. Specifically, the spline end 150 is engaged with an output gear 178 of the gearset 160 and extends to the flange end 152 for engaging the wheel 128. The axle shafts 148 define a drive axis 164 that extends through the rear axle 124, 126 and is the axis of rotation of the wheels 128. Additionally, each motor 158 defines a motor axis 166 with each motor axis 166 spaced from, and generally parallel to, the drive axis 164.

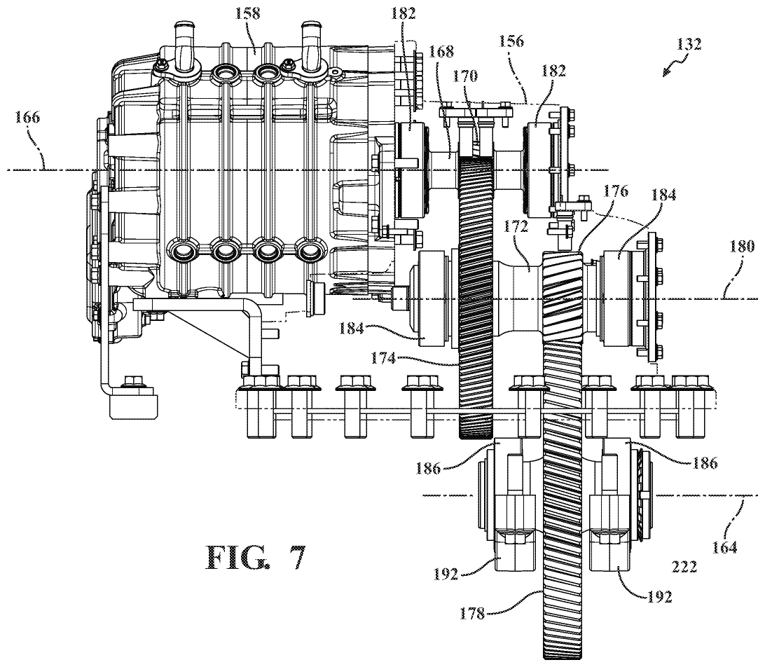

In FIG. 7, one of the carrier assemblies 132 is shown from the bottom and with the carrier housing 156 in phantom. In this view further details of the gearset 160 can be seen. More specifically, the gearset 160 may comprise an input shaft 168 rotatably supported by the carrier housing 156 and having an input gear 170. The gearset 160 may further comprise an intermediate shaft 172 rotatably supported by the carrier housing 156. A first intermediate gear 174 and a second intermediate gear 176 may be supported on the intermediate shaft 172 with the first intermediate gear engaged 176 with the input gear 170. The gearset 160 may further comprise the output gear 178 rotatably supported by the carrier housing 156 and engaged with the second intermediate gear 176.

Compared to the top view of FIG. 6, the bottom view of FIG. 7 shows the motor 158 oriented in a different direction. Said differently, the motor 158 is facing in a different direction due to the perspective of FIG. 7. As will be discussed in further detail below, each motor 158 comprises a stator and a rotor supported for rotation in the stator. The rotor has an output shaft 200 that is engaged with the input shaft 168 for concurrent rotation therewith. As can be seen, the input shaft 168 is positioned along the motor axis 166, which is positioned higher (i.e., a greater distance to the road surface) than the intermediate shaft 172. Furthermore, the intermediate shaft 172 defines an intermediate axis 180, which is parallel to, and longitudinally spaced between, the motor axis 166 and the drive axis 164.

The input shaft 168, the intermediate shaft 172, and the output gear 178 are each rotatably supported by the carrier housing 156 by bearings. Each shaft is supported by two bearings on opposing ends of the shaft. More specifically, the input shaft 168 is supported by two input bearings 182, the intermediate shaft 172 is supported by two intermediate bearings 184, and the output gear 178 is supported by two output bearings 186. The bearings are supported by the carrier housing 156 to facilitate low friction operation of the gearset 160. As can be seen in FIG. 7, the output bearings 186 are positioned outside the carrier housing 156. Said differently, the output bearings 186 are spaced away from an interior 190 of the carrier housing 156 so as to be arranged inside the axle housing 130 when the carrier housing 156 is coupled thereto. The input bearings 182 and the intermediate bearings 184 may be pressed into the carrier housing 156 during assembly of the carrier assembly 132. In contrast, the output bearings 186 may be pressed onto the output gear 178 and retained to the carrier housing 156 with a bearing cap 192. The bearing cap 192 and the carrier housing 156 cooperate to define a split bearing journal configured to receive an assembly of the output gear 178 and the output bearings 186, which is retained with a pair of fasteners.

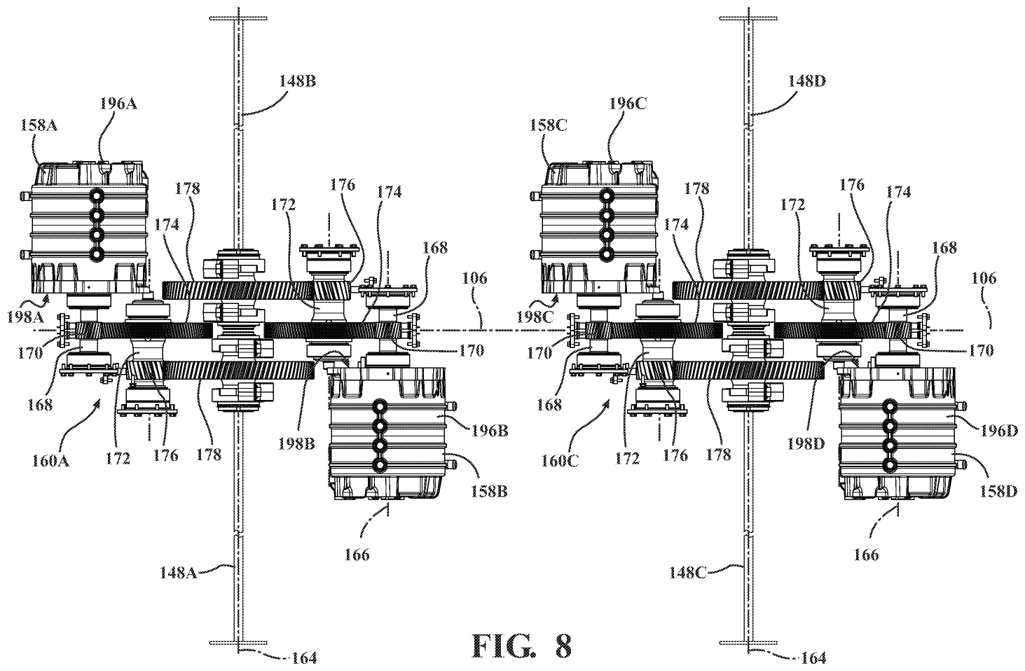

Referring now to FIG. 8, a schematic representation of the rear end 110 of the heavy-duty vehicle 100 is shown. Here, the first rear axle 124 and the second rear axle 126 are schematically shown without the axle housings 130A, 130B or carrier housings 156A, 156B. In other words, FIG. 8 depicts a first gearset 160A and a second gearset 160B arranged as the first rear axle 124 and further depicts a third gearset 160C and a fourth gearset 160D arranged as the second rear axle 126. Each of the gearsets 160A-160D is shown engaged with a corresponding axle shaft i.e., the first gearset 160A is engaged with a first axle shaft 148A, the second gearset 160B is engaged with a second axle shaft 148B, the third gearset 160C is engaged with a third axle shaft 148C, and the fourth gearset 160D is engaged with a fourth axle shaft 148D.

Unlike an axle where each are the axle shafts are mechanically coupled by way of a differential, each of the axle shafts 148 of the rear axles 124, 126 are mechanically separate and rotate independently from each other. Said differently, the first gearset 160A is rotationally independent from the second gearset 160B, and the third gearset 160C is rotationally independent from the fourth gearset 160D. Due to the mechanically separate arrangement of the carrier assemblies 132 on the axle housing 130, each of the carrier assemblies 132 for one of the rear axles 124, 126 may be substantially identical to each other. Likewise, the gearsets 160 may be substantially identical to each other. The first gearset 160A may be substantially identical to the second gearset 160B, and the third gearset 160C may be substantially identical to the fourth gearset 160D. Further, the gearsets 160 may be substantially identical between the first rear axle 124 and the second rear axle 126. The first gearset 160A may be substantially identical to the third gearset 160C, and the second gearset 160B may be substantially identical to the fourth gearset 160D. Further still, the first gearset 160A may be substantially identical to each of the second gearset 160B, the third gearset 160C, and the fourth gearset 160D.

Certain implementations of the rear axle 124, 126 may comprise a virtual differential, implemented through software controls, which operates each of the wheels 128 on each rear axle 124, 126 at a different speed in response to steering inputs of the heavy-duty vehicle 100. Additionally, the first rear axle 124 and the second rear axle 126 may be electrically linked with a second virtual differential, which allows the first rear axle 124 to rotate at a speed different than that of the second rear axle 126.

Known methods of differentiating rotational speed between each of the axle shafts include a differential, which uses a series of gears arranged in an interconnected manner to simultaneously drive both axle shafts at different speeds. Differentials are particularly useful for vehicle drive axles because, as the vehicle is turning one wheel travels a greater distance than the other, and therefore must rotate faster. In the present implementation, the aforementioned virtual differential commands the motors 158 to operate as different speeds as the heavy-duty vehicle 100 is turning.

In order to operate each wheel 128 individually, the first and second rear axles 124, 126 each comprise two motors 158. More specifically, a first motor 158A is directly mounted to the first carrier housing 156A, and a second motor 158B is directly mounted to the second carrier housing 156B. Likewise, a third motor 158C is directly mounted to the third carrier housing 156C, and a fourth motor 158D is directly mounted to the fourth carrier housing 156D. As mentioned above, some of the motors may be different than one another. In the implementation described herein, the first motor 158A and the second motor 158B may both be permanent magnet motors. The third motor 158C and the fourth motor 158D may both be induction motors. It should be appreciated that the designations such as first, second, third, and fourth are used to aid in describing the subject matter and are not limited as to the specific location or arrangement of the motors in the heavy-duty vehicle 100.

By implementing both induction motors and permanent magnet motors in the same heavy-duty vehicle 100, the advantageous characteristics of each are able to be utilized. More specifically, the power and torque delivery advantages of an induction motor can be combined with the increased efficiency of a permanent magnet motor. For example, because permanent magnet motors do not need to draw power to generate a magnetic field it is possible to achieve highly efficient operation. However, due to the magnetic field from the permanent magnets the efficiency may be reduced at high operating speeds. Similarly, the permanent magnet motor has a smaller window for operating at maximum efficiency i.e., the efficiency is reduced when the motor is operating near maximum speed or maximum torque.

The advantageous characteristics of an induction motor may overcome some of the disadvantages of a permanent magnet motor. For example, the induction motor is capable of operating more efficiently at near maximum speed and/or near maximum torque. Furthermore, the induction motor offers advantageous starting characteristics. However, induction motors do not offer the same level of peak efficiency as permanent magnet motors due to the current used to generate the magnetic field. In the exemplary implementation of the motors 158 described herein, both permanent magnet motors and induction motors are utilized to take advantage of the characteristics of each.

It should be appreciated that the instantaneous power requirements of the heavy-duty vehicle 100 can vary by a large degree and depend on many external factors. For example, the power required for launch (i.e., accelerate from a stop) and grading (i.e., climbing a hill) is much greater than the power required to maintain a steady-state speed on a level roadway. Additionally, these conditions are more greatly affected by the weight of the heavy-duty vehicle 100 and the cargo than steady-state operation. Said differently, the power required to accelerate from a stop when the heavy-duty vehicle 100 is fully loaded is much greater than the power required to accelerate from a stop when the heavy-duty vehicle 100 is unladen, whereas the power required to maintain a steady-state speed is comparatively unaffected by the weight of the cargo. Specifically, aerodynamic drag is the largest contributor to the power required to maintain a steady-state speed and overall weight is the largest contributor to the power required for launch and grading.

With the above considerations in mind, it will be appreciated that during operation of the heavy-duty vehicle 100, situations in which it is necessary to use the full power of the heavy-duty vehicle 100 are infrequent relative to the situations where only a fraction of that power is being used. Furthermore, the operating conditions of the heavy-duty vehicle 100 in some of these situations are more suited for one motor type. Specifically, the increased efficiency of the induction motor under high load is best suited for launch and grading, whereas the greater overall efficiency of the permanent magnet motor is best suited for steady state operation.

Further still, by utilizing a greater number of motors 158, each motor of the heavy-duty vehicle 100 may be smaller. When a greater number of motors are utilized, it is possible to more closely match the most efficient operating point of the motors 158 to the requirements of the vehicle. More specifically, a single motor capable of providing enough power to accelerate a fully loaded vehicle will not operate at peak efficiency when the heavy-duty vehicle 100 is driving at a steady-state speed. Conversely, a smaller motor can be operated at its peak efficiency to maintain a steady-state speed of the heavy-duty vehicle 100, and additional motors can provide additional power only when necessary.

In the exemplary implementation shown in FIG. 8, the first motor 158A and the second motor 158B are arranged on the first rear axle 124, whereas the third motor 158C and the fourth motor 158D are arranged on the second rear axle 126. Furthermore, the first rear axle 124 is shown arranged as a leading rear axle and the second rear axle is shown as a trailing rear axle. The first rear axle 124 may be arranged more toward the front end 108 of the heavy-duty vehicle 100 than the second rear axle 126. Likewise, the second rear axle 126 may be arranged more toward the rear end 110 of the heavy-duty vehicle 100 than the first rear axle 124. Said differently, the first rear axle 124 may be arranged on the centerline 106 of the heavy-duty vehicle 100 between the steering axle 120 and the second rear axle 126. In some implementations the first rear axle 124 and the second rear axle 126 could be arranged differently, such as with the second rear axle 126 as the leading rear axle and the first rear axle 124 as the trailing rear axle.

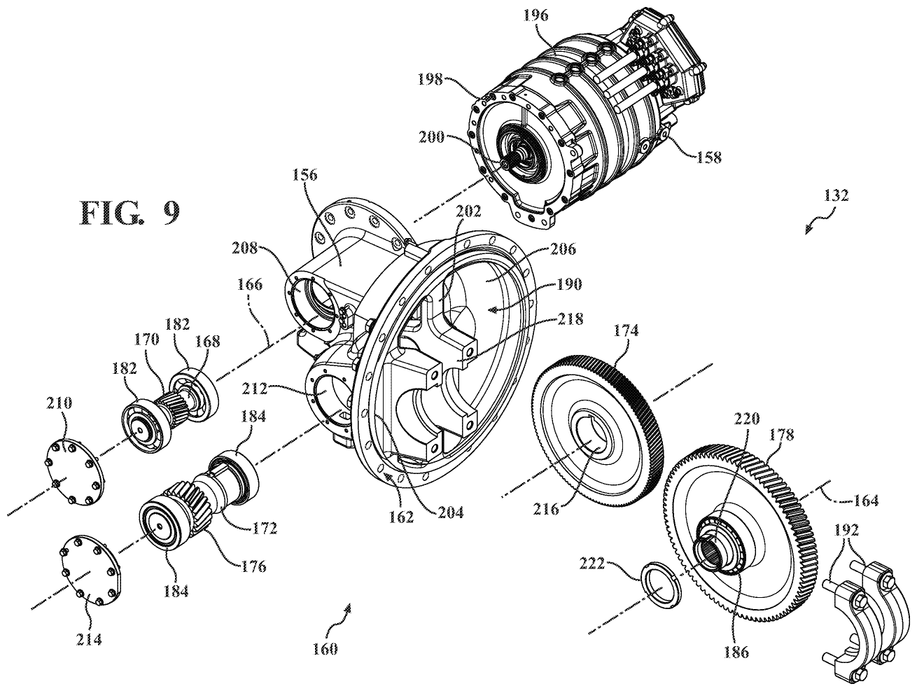

FIG. 8 further illustrates details of the arrangement of each of the motors relative to each other. Each of the motors 158A, 158B, 158C, 158D comprises a rotor rotatably supported in a stator. The stator comprises a motor housing 196, which is configured to be coupled to the respective carrier housing 156 in order for the rotor to engage the input shaft 168. The stator further comprises a mounting face 198 on one side of the motor housing 196, which is generally perpendicular to the motor axis 166. The rotor comprises an output shaft 200 (FIG. 9), which is configured to engage the input shaft 168 for transferring torque thereto. The output shaft 200 extends along the motor axis 166 to protrude from the mounting face 198 for engaging the input shaft 168. To this end, the direction that the output shaft 200 protrudes corresponds to a facing direction of the mounting face 198.

Because each of the motors 158A, 158B, 158C, 158D and the corresponding gearset 160A, 160B, 160C, 160D are rotationally independent of each other, each motor 158A, 158B, 158C, 158D is engaged with exactly one of the axle shafts 148A, 148B, 148C, 148D. As shown in FIG. 8, the motor 158 and the corresponding axle shaft 148 are arranged on opposing sides of the centerline 106. The first motor 158A is arranged across the centerline from the first axle shaft 148A with the mounting face 198A facing the first axle shaft 148A and toward the first wheel first wheel 128A. The second motor 158B is arranged across the centerline from the second axle shaft 148B with the mounting face 198B facing the second axle shaft 148B and toward the second wheel second wheel 128B. The third motor 158C is arranged across the centerline from the third axle shaft 148C with the mounting face 198C facing the third axle shaft 148C and toward the third wheel third wheel 128C. The fourth motor 158D is arranged across the centerline from the fourth axle shaft 148D with the mounting face 198D facing the fourth axle shaft 148D and toward the third wheel fourth wheel 128D.

Furthermore, the motors 158 on each of the rear axles 124, 126 are arranged with the mounting face 198 facing in opposite directions and facing each other. Because each motor 158 is arranged across the centerline 106 from the corresponding wheel 128 and with the mounting face 198 facing toward the corresponding wheel 128, the mounting face 198 of each motor 158 faces the mounting face 198 of the other motor 158. More specifically and with reference to the first rear axle 124, the first motor 158A is arranged and oriented such that the mounting face 198A is facing the mounting face 198B of the second motor 158B. With reference to the second rear axle 126, the third motor 158C is arranged and oriented such that the mounting face 198C is facing the mounting face 198D of the fourth motor 158D.

Further details of the carrier assembly 132 are shown in the exploded view of FIG. 9. Here, the motor 158 and gearset 160 are shown spaced from the carrier housing 156 and each other. As mentioned above, the carrier housing 156 defines the interior 190, in which the gearset 160 is at least partially supported. The carrier housing 156 further defines a bearing strut 202 extending across the carrier flange 162. The bearing strut 202 and the carrier flange 162 cooperate to define a first opening 204 and a second opening 206 into the interior 190 of the carrier housing 156. The first opening 204 and the second opening 206 allow access to the interior 190 for assembly. The bearing strut 202 may extend across a chord of the carrier flange 162 such that the first opening 204 and the second opening 206 are arranged on either side of the bearing strut 202.

FIG. 9 further shows two ports defined in the carrier housing 156. An input port 208 and an intermediate port 212 are defined in one side of the carrier housing 156 for providing access during assembly. Each of the ports further comprises a cover to enclose and seal the interior 190. An input port cover 210 is coupled to the carrier housing 156 adjacent to the input port 208 and an intermediate port cover 214 is coupled to the carrier housing 156 adjacent to the intermediate port 212. In addition to allowing access during assembly, the ports 208, 212 support an outer race of the corresponding shaft bearings. The input port 208 supports the outer race of one of the input bearings 182 and the intermediate port 212 support the outer race of one of the intermediate bearings 184.

A first portion of the gearset 160 may arranged in the first opening 204 of the interior 190 and a second portion of the gearset 160 may be arranged in the second opening 206 of the interior 190. In the exploded view of FIG. 9, the output gear 178 is shown spaced out of the first opening 204 of the carrier housing 156 and the first intermediate gear 174 is shown spaced out of the second opening 206. As mentioned above, the first intermediate gear 174 is rotatably supported by the intermediate shaft 172 with a portion of the first intermediate gear 174 arranged in the second opening 206 partially within the interior 190. The intermediate gear 174 may define a keyed bore 216 engageable with the intermediate shaft 172. A portion of the intermediate shaft 172 may comprise a key configured for corresponding engagement with the keyed bore 216 for transferring torque therebetween. The second intermediate gear 176 is arranged opposite the key on the intermediate shaft 172, and in some cases may be integrally formed with the intermediate shaft 172. Said differently, the intermediate shaft 172 and the second intermediate gear 176 may be formed together as a monolithic component. Other implementations of the intermediate shaft 172 and the second intermediate gear 176 may be rotationally coupled using a key similar to the first intermediate gear 174.

Similarly, the input gear 170 is rotatably supported in the interior 190 by the input shaft 168. The input gear 170 may be integrally formed with the input shaft 168. Said differently, the input gear 170 and the input shaft 168 may be formed together as a monolithic component. Other implementations of the input shaft 168 and input gear 170 may be rotationally coupled using a key similar to the first intermediate gear 174 and the intermediate shaft 172.

Unlike the input gear 170 and the second intermediate gear 176, the output gear 178 may be rotatably supported only partially in the interior 190. The output gear 178 is rotatably supported by a journal portion 218 of the bearing strut 202 with a portion of the output gear 178 arranged in the first opening 204 partially within the interior 190. In further contrast to the input gear 170 and the intermediate gears 174, 176, the output gear 178 may comprise two stub shafts 220 protruding along the drive axis 164. The stub shafts 220 may define a splined output bore engageable with the spline end 150 of the axle shaft 148. The stub shafts 220 may have an outer threaded portion and a preload nut 222 that cooperate to exert a preload force on the output bearings 186.

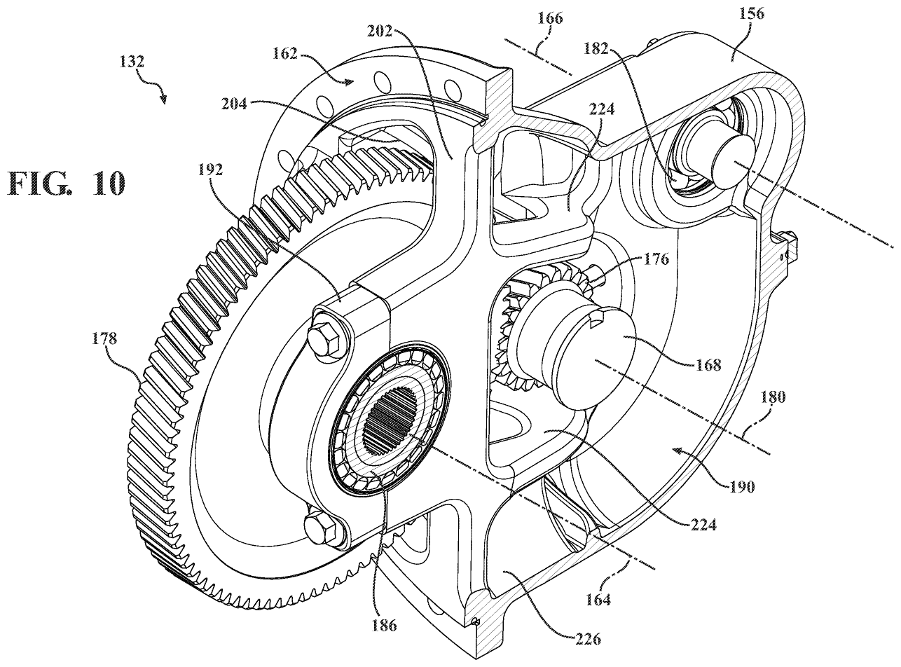

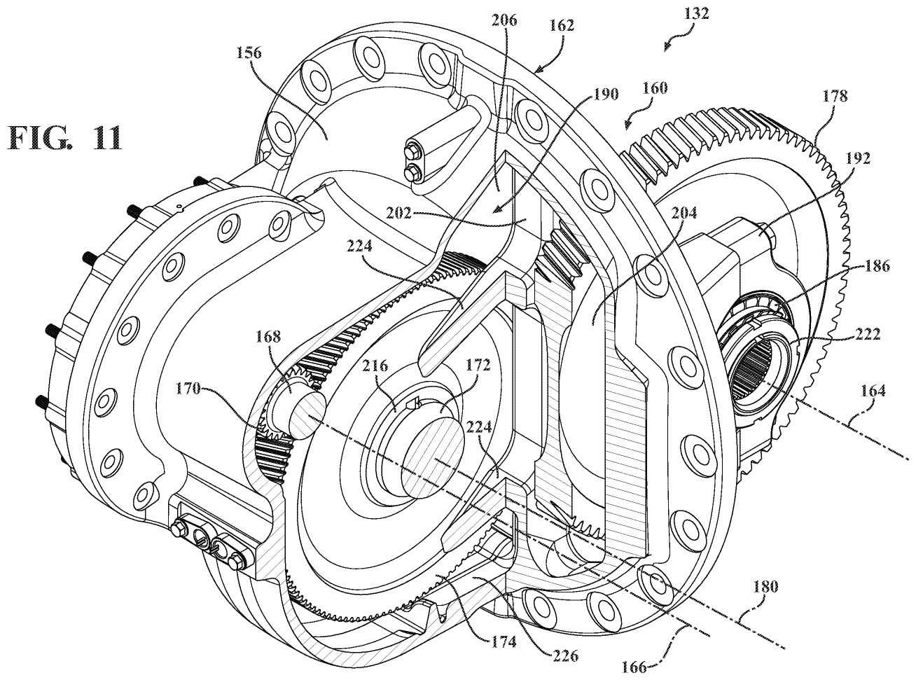

Turning now to FIGS. 10 and 11, further details of the carrier housing 156 and the interior 190 are shown. FIG. 10 is a cross-sectional view of the interior 190 from the carrier flange 162 depicting the bearing strut 202 and the journal portion 218. The bearing strut 202 cooperates with the carrier flange 162 to define the openings 204, 206 to the interior 190. As mentioned above, the bearing strut 202 comprises the journal portion 218, which cooperates with one of the bearing caps 192 to support one of the output bearings 186. Opposite the journal portion 218 of the bearing strut 202 is an open portion of the interior 190. An opening behind the bearing strut 202 allows the interior 190 to be continuous within the carrier housing 156. The carrier housing 156 may further comprise two strut braces 224 that extend from the bearing strut 202 to prevent forces from the output gear 178 on the journal portion 218 from deforming the bearing strut 202.

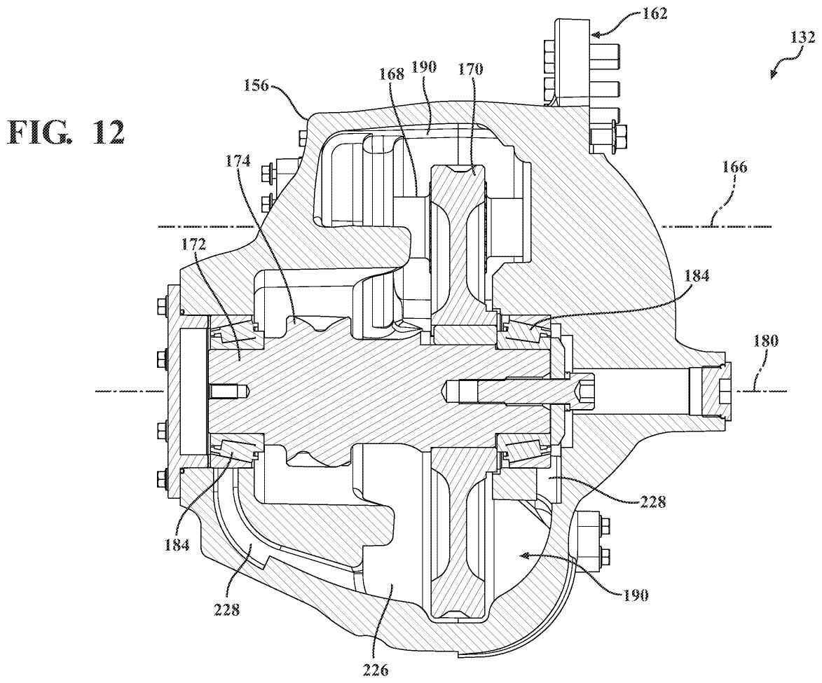

The cross-sectional view of FIG. 12 depicts the intermediate shaft 172 and the second intermediate gear 176 supported by the intermediate bearings 184. Here, lubrication details of the intermediate bearings 184 are also shown. Specifically, the carrier housing 156 further defines a sump 226 and two lubricant drains 228. The sump 226 may be a continuous portion of the interior 190 or a separate chamber. The sump 226 is generally the lowest portion of the carrier housing 156 such that lubricant (e.g., gear oil) can drain to be recirculated for lubricating contact surfaces of the gearset 160. Here, a portion of the first intermediate gear 174 is positioned in the sump 226 such that as the first intermediate gear 174 rotates, lubricant in the sump 226 contacts the first intermediate gear 174 and is carried to other components in the gearset 160. Lubricant is further carrier or splashed to contact surfaces in the bearings. In order to return excess lubricant from the bearings to the sump 226, the drains 228 are formed in the carrier housing 156 as passages in direct communication with the sump 226. In FIG. 12, the drains 228 for the intermediate bearings 182 are shown, with each drain 228 having an opening adjacent to one of the intermediate bearings 182 and an outlet in the sump 226. In some implementations the carrier housing 156 may further define drains extending between the input bearings 182 and the sump 226.

With reference to FIG. 13, the arrangement of the gearset 160 is shown relative to a roadway 118 surface. Specifically, the relative height of each of the axes 164, 166, 180 to the roadway 118 is depicted, with the top of FIG. 13 generally corresponding to an upward direction. The drive axis 164, about which the output gear 178 and the wheels 128 rotate, is spaced from the roadway 118 by a distance H1. The motor axis 166, about which the motor 158 and the input shaft 168 rotate, is spaced from the roadway 118 by a distance H2. The intermediate axis 180, about which the intermediate shaft 172 and the intermediate gears 174, 176 rotate, is spaced from the roadway 118 by a distance of H3. As mentioned above, the motor axis 166 is arranged above the drive axis 164 or in other words, the distance H2 is greater than the distance H1. Additionally, the distance H3 is less than the distance H1 such that the intermediate axis 180 is arranged above the drive axis 164. In this way the first intermediate gear 174 is the lowest (i.e., nearest to the roadway 118) component of the gearset 160. As such, the first intermediate gear 174 is positioned partially in the sump 226 (FIG. 12) in contact with the lubricant to facilitate distributing lubricant to the various contact surfaces. Furthermore, FIG. 13 shows the longitudinal spacing of each of the axes 164, 166, 180. The motor axis 166 is spaced further from the drive axis 164 than the intermediate axis 180. Said differently, the intermediate axis 180 is longitudinally arranged between the motor axis 166 and the drive axis 164.

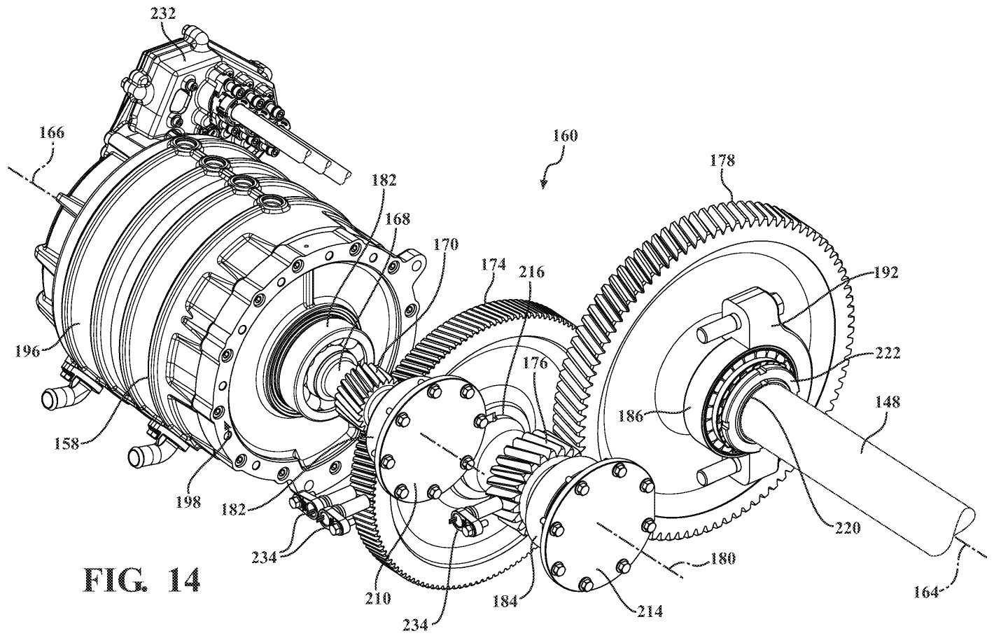

Referencing now FIGS. 3, 5, 13, and 14, the heavy-duty vehicle 100 may further comprise a motor controller 232 and at least four wheel speed sensors 234. The motor controller 232 is in electrical communication with each of the motors 158A, 158B, 158C, 158D and is configured for sending control signals controlling the rotational speed of each of the motors 158A, 158B, 158C, 158D. In order to implement the virtual differentials described above, the motor controller 232 is configured to receive signals from each of the wheel speed sensors 234 corresponding to the rotational speed of each wheel. Each control wheel speed sensor 234 measures the rotational speed of one of the wheels 128, and therefore the corresponding motor 158, to be used as feedback when operating each of the rear axles 124, 126. The motor controller 232 may receive input signals from other sensors on the heavy-duty vehicle 100 such as a yaw sensor, a steering sensor, and a pedal position sensor. These signals indicate vehicle status such as a turning rate, a desired turning radius, and a desired vehicle speed.

Each of the wheel speed sensors 234 may further be used by the motor controller 232 to facilitate traction control for the heavy-duty vehicle 100. For example, the virtual differential can replicate a limited slip or locking differential if wheel slip is detected, the power supplied to one of the motors 158 can be reduced and/or sent to another motor 158 in order to maximize the tractive forces while accelerating. In this way, the virtual differential can reduce a loss of traction, which may lead to a loss of vehicle control, or the heavy-duty vehicle 100 becoming stuck on loose surfaces. In some implementations, the heavy-duty vehicle 100 may comprise more than four wheel speed sensors 234. For example, redundant wheel speed sensors can be used to verify the signal received from each other in an error checking arrangement. Additional sensors can also be used to cancel out potential electrical interference, which may result in erroneous signals.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A heavy-duty vehicle having a chassis extending along a centerline, the heavy-duty vehicle comprising:
a front steering axle having a pair of wheels configured for movement relative to the centerline;
a first rear axle comprising:
a first axle housing coupled to the chassis and supporting a first axle shaft coupled to a first wheel and a second axle shaft coupled to a second wheel with the first and second wheels arranged on opposing sides of the centerline;
a first carrier housing coupled to the first axle housing;
a first permanent magnet motor mounted directly to the first carrier housing for driving the first wheel;
a first gearset rotatably supported at least partially in the first carrier housing and operatively engaged between the first permanent magnet motor and the first axle shaft;
a second carrier housing coupled to the first axle housing;
a second permanent magnet motor coupled to the second carrier housing for driving the second wheel;
a second gearset rotatably supported at least partially in the second carrier housing and operatively engaged between the second permanent magnet motor and the second axle shaft; and
wherein the first gearset is rotationally independent from the second gearset;
a second rear axle comprising;
a second axle housing coupled to the chassis and supporting a third axle shaft coupled to a third wheel and a fourth axle shaft coupled to a fourth wheel with the third and fourth wheels arranged on opposing sides of the centerline;
a third carrier housing coupled to the second axle housing;
a first induction motor mounted directly to the third carrier housing for driving the third wheel;
a third gearset rotatably supported at least partially in the third carrier housing and operatively engaged between the first induction motor and the third axle shaft;
a fourth carrier housing coupled to the second axle housing;
a second induction motor mounted directly to the fourth carrier housing for driving the fourth wheel;
a fourth gearset rotatably supported at least partially in the fourth carrier housing and operatively engaged between the second induction motor and the fourth axle shaft; and
wherein the third gearset is rotationally independent from the fourth gearset.

2. The heavy-duty vehicle of claim 1, wherein the heavy-duty vehicle is a fully electric vehicle.

3. The heavy-duty vehicle of claim 1, wherein the first carrier housing and the second carrier housing are arranged on opposing sides of the first axle housing and spaced along the centerline; and
wherein the third carrier housing and the fourth carrier housing are arranged on opposing sides of the second axle housing and spaced along the centerline.

4. The heavy-duty vehicle of claim 1, wherein the first axle shaft and the second axle shaft define a first drive axis, and wherein the first permanent magnet motor and the second permanent magnet motor are arranged parallel to the first drive axis.

5. The heavy-duty vehicle of claim 4, wherein the first permanent magnet motor defines a first motor axis and wherein the first motor axis is spaced further from a road surface than the first drive axis.

6. The heavy-duty vehicle of claim 4, wherein the third axle shaft and the fourth axle shaft define a second drive axis, and wherein the first induction motor and the second induction motor are arranged parallel to the second drive axis.

7. The heavy-duty vehicle of claim 1, wherein the first gearset comprises:
an input shaft rotatably supported by the first carrier housing and having an input gear;
an intermediate shaft rotatably supported by the first carrier housing and having a first intermediate gear and a second intermediate gear, wherein the first intermediate gear is engaged with the input gear; and
an output gear rotatably supported by the first carrier housing and engaged with the second intermediate gear and the first axle shaft.

8. The heavy-duty vehicle of claim 1, wherein the first gearset is substantially identical to the second gearset.

9. The heavy-duty vehicle of claim 8, wherein the third gearset is substantially identical to the fourth gearset.

10. The heavy-duty vehicle of claim 9, wherein the third gearset and the fourth gearset are substantially identical to the first gearset.

11. The heavy-duty vehicle of claim 1, wherein the first permanent magnet motor and the second permanent magnet motor each comprises a stator having a mounting face, wherein the first permanent magnet motor is oriented with the mounting face facing the mounting face of the second permanent magnet motor.

12. The heavy-duty vehicle of claim 11, wherein the mounting face of the first permanent magnet motor is oriented facing toward the first wheel, and the mounting face of the second permanent magnet motor is oriented facing toward the second wheel.

13. The heavy-duty vehicle of claim 11, wherein the mounting face of the first permanent magnet motor is positioned across the centerline from the first wheel, and the mounting face of the second permanent magnet motor is positioned across the centerline from the second wheel.

14. The heavy-duty vehicle of claim 11, wherein the first induction motor and the second induction motor each comprises a stator having a mounting face, wherein the first induction motor is oriented with the mounting face facing the mounting face of the second induction motor.

15. The heavy-duty vehicle of claim 14, wherein the mounting face of the first induction motor is oriented facing toward the third wheel, and the mounting face of the second induction motor is oriented facing toward the fourth wheel.

16. The heavy-duty vehicle of claim 15, wherein the mounting face of the first induction motor is positioned across the centerline from the third wheel, and the mounting face of the second induction motor is positioned across the centerline from the fourth wheel.

17. The heavy-duty vehicle of claim 1, wherein the first carrier housing defines an interior volume and comprises a carrier flange engageable with the first axle housing and a bearing strut extending across the carrier flange, and wherein the carrier flange and the bearing strut cooperate to define a first opening and a second opening to the interior volume.

18. The heavy-duty vehicle of claim 17, wherein a portion of the first gearset is arranged in the first opening of the interior volume, and a second portion of the first gearset is arranged in the second opening of the interior volume.

19. The heavy-duty vehicle of claim 1, further comprising:
at least four wheel speed sensors for measuring a rotational speed of each of the wheels; and
a motor controller in communication with the first permanent magnet motor, the second permanent magnet motor, the first induction motor, the second induction motor, and the at least four wheel speed sensors, wherein the motor controller is configured to operate the first rear axle at a different speed than the second rear axle.

20. The heavy-duty vehicle of claim 1, wherein the first rear axle is arranged on the centerline between the front steering axle and the second rear axle.

21. A driveline system for a heavy-duty vehicle including a chassis, a front steering axle coupled to the chassis and having a pair of wheels arranged on opposing sides of a vehicle centerline and configured for turning the heavy-duty vehicle, the driveline system comprising:
a first rear axle comprising:
a first axle housing coupled to the chassis and supporting a first axle shaft coupled to a first wheel and a second axle shaft coupled to a second wheel with the first and second wheels arranged on opposing sides of the vehicle centerline;
a first permanent magnet motor coupled to the first axle housing for driving the first wheel;
a first gearset operatively engaged between the first permanent magnet motor and the first axle shaft;
a second permanent magnet motor coupled to the first axle housing for driving the second wheel; and
a second gearset operatively engaged between the second permanent magnet motor and the second axle shaft; and
a second rear axle comprising;
a second axle housing coupled to the chassis and supporting a third axle shaft coupled to a third wheel and a fourth axle shaft coupled to a fourth wheel with the third and fourth wheels arranged on opposing sides of the centerline;
a first induction motor coupled to the second axle housing for driving the third wheel;
a third gearset operatively engaged between the first induction motor and the third axle shaft;
a second induction motor coupled to the second axle housing for driving the fourth wheel; and
a fourth gearset operatively engaged between the second induction motor and the fourth axle shaft.

22. The driveline system of claim 21, wherein the first gearset is rotationally independent from the second gearset and the third gearset is rotationally independent from the fourth gearset.
